(19) United States
(12) Patent Application Publication
(10) Pub. No.: US 2007/0066119 A1
(43) Pub. Date: Mar. 22, 2007

(54) Memory device with serial AT attachment

(76) Inventors: Tsung-Chu Wu, Hsinchu City (TW); Peng-Fei Lin, Hsinchu City (TW)

Correspondence Address: LIN & ASSOCIATES INTELLECTUAL PROPERTY, P.O. BOX 2339, SARATOGA, CA, 95070-0339, US

(21) Appl. No.: 11/231,379

(22) Filed: Sep. 21, 2005

(51) Int. Cl. H01R 13/64

(52) U.S. Cl. 439/378

(57) ABSTRACT

A storage device with a SATA interface is provided. The storage device uses a SATA to interface with PC and notebook/laptop computers. The storage device includes a SATA connector, a SATA interface and a memory module. The memory module further includes memory chips, and a memory controller. The memory controller further includes a microprocessor controller, a set of operational registers, and a memory interface. The microprocessor controller further includes a display element for displaying the status of the storage device. With the SATA interface, the portable storage device can achieve higher transmission speed and better transmission quality than conventional portable storage devices using USB interface.

### FIELD OF THE INVENTION

The present invention generally relates to a memory device, and more specifically to a memory device with serial AT attachment (SATA).

### BACKGROUND OF THE INVENTION

Since the emergency of IBM's PC/AT, PC or laptop computer has become ubiquitous. The AT attachment (ATA) or the ATA packet interface (ATAPI) between AT and devices has become the most popular device interface. For example, more than 90% of the harddisks use ATA interface, and the remaining uses SCSI interface. In addition, the majority of CD-ROM uses ATAPI, and the majority of PCMCIA and CFA mass storage devices also use ATA or ATAPI interface.

Serial ATA (SATA) is the newest version of the ATA interface. SATA supports the entire conventional parallel ATA interface. The single lane interface uses only seven pins, which is far less than the 40 pins used by the conventional parallel ATA interface. Furthermore, the transmission speed of SATA interface can reach as high as 3 Gbps.

The portable harddisk, or conventional referred to as flash memory pen or flash memory stick because of using flash memory as storage element, has become the most popular portable storage device due to compact size and increasing capacity. The flash memory sticks usually use USB as transmission interface. FIG. 1 shows a schematic view of a conventional USB-interfaced storage device. The present USB 2.0 allows up to 480 Mbps in transmission. As the capacity of flash memory sticks increases, from the MB range to the GB range, the USB-based transmission interface will soon face the transmission speed problem.

### SUMMARY OF THE INVENTION

The present invention has been made to overcome the above-mentioned drawback of conventional transmission speed problem caused by the increasing storage capacity of portable storage devices. The primary object of the present invention is to provide a portable storage device with a SATA interface. The portable storage device of the present invention uses SATA to interface with PC and notebook/laptop computers. Therefore, the portable storage device can achieve higher transmission speed and better transmission quality than conventional portable storage devices using USB interface.

In the preferred embodiment of the present invention, a SATA connector is connected to a memory module through a SATA interface. The memory module includes memory chips, and the memory controller of the present invention. The memory controller further includes a microprocessor controller, a set of operational registers, and a memory interface. The microprocessor controller further includes a display element for displaying the status of the storage device of the present invention.

The foregoing and other objects, features, aspects and advantages of the present invention will become better understood from a careful reading of a detailed description provided herein below with appropriate reference to the accompanying drawings.

### BRIEF DESCRIPTION OF THE DRAWINGS

The present invention can be understood in more detail by reading the subsequent detailed description in conjunction with the examples and references made to the accompanying drawings, wherein:

FIG. 1 shows a schematic view of the storage device with a conventional USB interface;

FIG. 2 shows a schematic view of a storage device with a SATA interface according to the present invention;

FIG. 3 shows a schematic view of the memory module of according to the present invention;

FIG. 4 shows a schematic view of the memory controller according to the present invention;

FIG. 5 shows a schematic view of the memory controller according to the present invention; and

FIG. 6 shows a block diagram of the SATA interface according to the present invention.

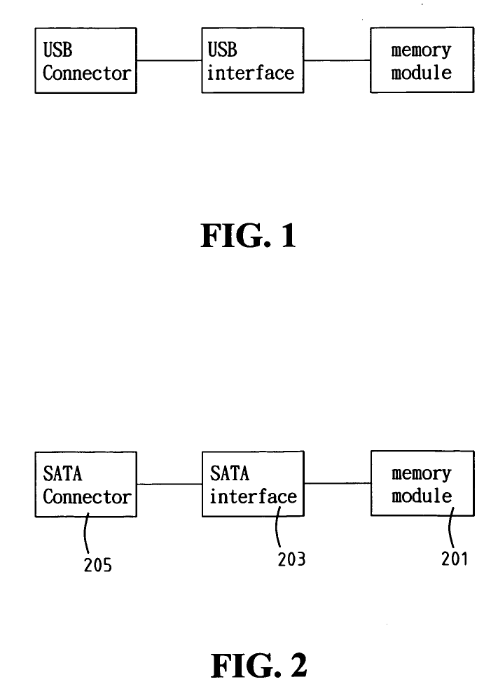

### DETAILED DESCRIPTION OF THE PREFERRED EMBODIMENTS

FIG. 2 shows a schematic view of a portable storage device with a SATA interface according to the present invention. The portable storage device of the present invention uses SATA to interface with PC and notebook/laptop computers. Therefore, the portable storage device can achieve higher transmission speed and better transmission quality than conventional portable storage devices using USB interface.

As shown in FIG. 2, the storage device with a SATA interface includes a memory module 201, a SATA interface 203 and a SATA connector 205. SATA interface 203 is connected to both memory module 201 and SATA connector 205, as shown in FIG. 2.

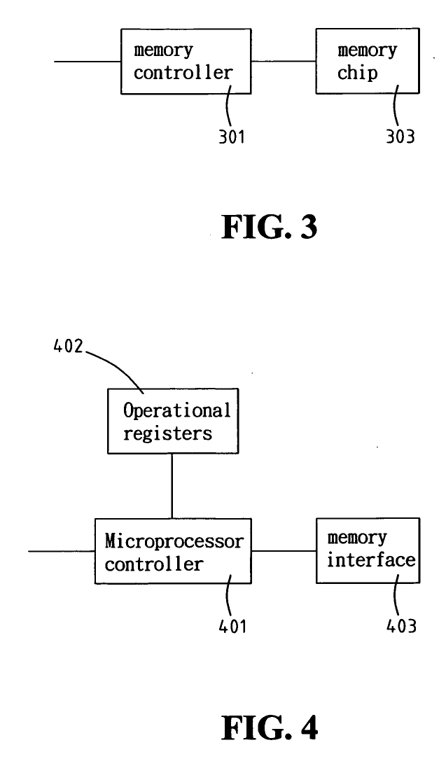

Memory module 201 of FIG. 2 further includes a memory controller 301 and a memory chip 303, as shown in FIG. 3. Memory controller 301 is for controlling the memory access to memory chip 303.

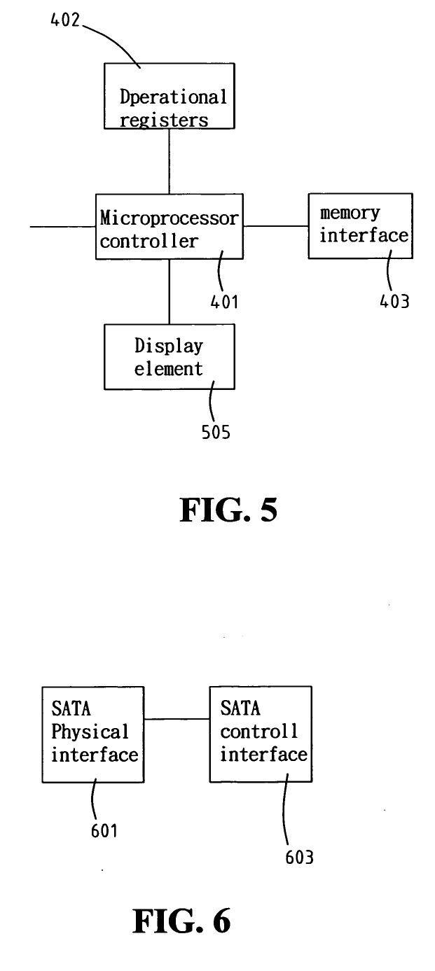

FIG. 4 and FIG. 5 show two embodiments of memory controller 301 of FIG. 3. In the embodiment shown in FIG. 4, memory controller 301 further includes a microprocessor 401, a set of operational registers 402 for temporary storage of data generated by microprocessor 401, and a memory interface 403 memory interface 403 processes all the hardware protocols, including command, address, and data sequence management, and accesses data stored in memory chip 303 through operational registers 402.

FIG. 5 shows another embodiment of memory controller 301. In this embodiment, memory controller 301 further includes a display element 505, connected to microprocessor controller 401. Display element 505 is for displaying the access status of the storage device of the present invention. Display element 505 can be an LED.

FIG. 6 shows a block diagram of SATA interface 203 shown in FIG. 2. SATA interface 203 further includes a SATA physical interface 601 and a SATA control interface 603.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A storage device with a SATA interface, comprising:
a memory module;
a SATA interface, connected to said memory module, further comprising a SATA physical interface and a SATA control interface; and
a SATA connector, connected to said SATA interface.

2. The device as claimed in claim 1, wherein said memory module further comprises:
a memory chip, for storing data; and
a memory controller, for controlling data access to said memory chip.

3. The device as claimed in claim 2, wherein said memory controller further comprises:
a microprocessor controller;
a set of operational registers, for temporary storage of data generated by said microprocessor controller; and
a memory interface.

4. The device as claimed in claim 3, further comprising a display element, connected to said microprocessor for displaying the access status of said device.

5. The device as claimed in claim 4, wherein said display element is an LED.
